(19) United States
(12) Patent Application Publication
(10) Pub. No.: US 2024/0315169 A1
(43) Pub. Date: Sep. 26, 2024

(54) CROP RESIDUE PERFORMANCE MONITORING SYSTEM AND METHOD OF MONITORING CROP RESIDUE

(71) Applicant: Deere & Company, Moline, IL (US)

(72) Inventors: Nathan R. Vandike, Geneseo, IL (US); Kelli L. Martin, Morton, IL (US); Mehul P. Bhavsar, Pune (IN); Bradley K. Yanke, Eldridge, IA (US)

(21) Appl. No.: 18/124,854

(22) Filed: Mar. 22, 2023

(51) Int. Cl. A01D 41/12; A01D 41/127

(52) U.S. Cl. CPC A01D 41/1243; A01D 41/127

(57) ABSTRACT

An agricultural machine includes a chassis and a header located at one end of the chassis. The header is configured to harvest a crop in a field. A spreader is located at an opposite end of the chassis and discharges a residue of the harvested crop in a rearward direction from the agricultural machine onto the field. An unloading conveyor has a first end coupled to the chassis and a second end that extends rearwardly from the chassis. A sensor is adjustably coupled to the unloading conveyor and senses a characteristic of the residue as the residue is discharged from the spreader and is distributed onto the field. The sensor is movably adjustable relative to the unloading conveyor.

### FIELD OF THE DISCLOSURE

The present disclosure generally relates to agricultural machines, and, more specifically, to systems and methods for monitoring crop residue discharged from agricultural machines.

### BACKGROUND

Agricultural machines such as combines harvest crop in a field. Once the crop is cut in the field, the grain is separated from the material other than grain (i.e., crop residue or residue). The crop residue is then discharged from the agricultural machine onto the field where it forms a residue spread pattern. The crop residue may be collected or used as a fertilizer in the field.

### SUMMARY

In one implementation of the present disclosure, an agricultural machine includes a chassis, a header coupled to the chassis and a spreader coupled to the chassis. The header is configured to harvest a crop in a field, and the spreader is configured to discharge a residue of the harvested crop in a rearward direction from the agricultural machine. An unloading conveyor includes a first end coupled to the chassis and a second end extending from the chassis. The agricultural machine also includes a sensor adjustably coupled to the unloading conveyor and configured to sense a characteristic of the residue as the residue is discharged from the machine by the spreader or has settled in the field. The sensor is movably adjustable relative to the unloading conveyor.

In a first example of this implementation, the sensor is directly coupled to the unloading conveyor and disposed at a location that is rearward of the spreader. In a second example, the sensor is pivotally coupled to the unloading conveyor. In a third example, the sensor is movably adjusted relative to the unloading conveyor to move between a top portion, a bottom portion, a first side portion, a second side portion, and a rear portion of the unloading conveyor.

In a fourth example, the sensor is movably adjusted relative to the unloading conveyor by a linear actuator or a rotary actuator.

In another example of this implementation, the unloading conveyor includes a track to which the sensor is movably coupled such that the sensor is movable along the track to any of a plurality of locations on the unloading conveyor. In some examples, the sensor may include a camera, radar, LIDAR, an ultrasonic sensor, infrared sensor or a thermal sensor.

In a further example, the sensor is coupled to the unloading conveyor at a first location that is rearward of the spreader such that the sensor is positioned to sense an area of the field that is forward of the first location and rearward of the spreader. In another example, the sensor is coupled to the unloading conveyor at a first location and positioned relative to the agricultural machine to de sense tect an area of the field that is directly below the first location. In other examples of the implementation according to the present disclosure, the sensor is coupled to the unloading conveyor at a first location and positioned relative to the agricultural machine to sense an area of the field that is rearward of the first location.

In a further example, the agricultural machine includes a controller disposed in communication with the sensor, and the sensor is configured to output the characteristic of the residue to the controller. In turn, the controller analyzes the characteristic of the residue and controllably adjusts a function of the agricultural machine to adjust the characteristic of the residue. In yet another example, following the analysis of the characteristic, the controller controllably adjusts a speed of the spreader, a shroud position of the spreader, or a spread pattern.

In another implementation of the present disclosure, an agricultural machine for harvesting crop includes a chassis, a header coupled to the chassis, and a spreader coupled to the chassis. The header is configured to harvest crop in a field, and the spreader is configured to discharge a residue of the harvested crop in a rearward direction from the agricultural machine. The agricultural machine includes an unloading conveyor having a first end and a second end. The first end of the unloading conveyor is movably coupled to the chassis, and the second end extends outwardly from the chassis. The agricultural machine also includes a sensor coupled to the unloading conveyor and configured to sense a characteristic of the residue discharged from the spreader. The sensor is coupled to a top portion or side portion of the unloading conveyor.

In one example of this implementation, the unloading conveyor extends outwardly from the chassis in the rearward direction and overhangs a portion of the field rearward of the agricultural machine. The sensor is located at a first location on the unloading conveyor at a distance spaced rearwardly of the spreader, and the sensor is oriented in a forward direction to sense an area of the field defined between the spreader and the first location. In another example, the sensor is pivotally coupled to the unloading conveyor. In a further example, the sensor is movably coupled to the unloading conveyor. In yet another example, the sensor is movably coupled relative to the unloading conveyor to move between any of a plurality of locations on the top portion, a bottom portion, the side portion, and a rear portion of the unloading conveyor.

In a further implementation of the present disclosure, a method of controlling a spread pattern of crop residue discharged from an agricultural machine during a harvesting operation includes providing the agricultural machine with a header, a spreader, an unloading conveyor, and a sensor. The method includes harvesting a crop in a field by the header, discharging the crop residue by the spreader from the agricultural machine, positioning the sensor at a location on the unloading conveyor that is spaced rearwardly of the spreader, and orienting the sensor in a forward direction towards the agricultural machine to sense an area of the field defined between the spreader and the location of the sensor on the unloading conveyor. The method further includes sensing a distribution of the crop residue by the sensor as the crop residue is discharged from the agricultural machine or has settled in the area of the field.

In one example of this implementation, the method includes outputting by the sensor an output signal indicative of the distribution of the crop residue, determining if a quality of the output signal satisfies a threshold, operably moving the sensor to a new location or new orientation relative to the unloading conveyor if the quality of the output signal does not satisfy the threshold, and repeatedly sensing the distribution of the crop residue until the quality of the output signal satisfies the threshold.

In another example of this implementation, the method includes analyzing the output signal to determine the spread pattern of the crop residue, determining based on the spread pattern if a function of the agricultural machine needs to be adjusted, and controlling the function of the agricultural machine.

These and other features of the present disclosure will become more apparent from the following description of the illustrative implementations.

### BRIEF DESCRIPTION OF THE DRAWINGS

The above-mentioned aspects of the present disclosure and the manner of obtaining them will become more apparent and the disclosure itself will be better understood by reference to the following description of the implementations of the disclosure, taken in conjunction with the accompanying drawings, wherein:

FIG. 1 is a partial section of a side view of an example agricultural machine according to the present disclosure;

FIG. 2 is a partial perspective view of a rear portion of an example agricultural machine with a sensor having a first configuration;

FIG. 3 is a partial perspective view of a rear portion of an example agricultural machine with the sensor of FIG. 2 having a second configuration;

FIG. 4 is a partial perspective view of a rear portion an example agricultural machine with the sensor of FIG. 2 having a third configuration; and

FIG. 5 is a flowchart of an example method for sensing and controlling a crop residue spread pattern.

Corresponding reference numerals are used to indicate corresponding parts throughout the several views.

### DETAILED DESCRIPTION

The implementations of the present disclosure described below are not intended to be exhaustive or to limit the disclosure to the precise forms in the following detailed description. Rather, the implementations are chosen and described so that others skilled in the art may appreciate and understand the principles and practices of the present disclosure.

During a harvesting operation, crop residue is discharged from an agricultural machine such as a combine and the crop residue may be left in a field after the crop is harvested. Crop residue management can improve soil quality by, for example, improving soil structure, increasing organic matter content in the soil, reducing erosion, and reducing weed growth. But if crop residue is not uniformly spread over the agricultural land during the harvesting operation, crop residue piles may form in the field which can facilitate non-uniform seed placement during subsequent seeding operations. Many variables can make it difficult to uniformly spread crop residue over agricultural land such as, for example, variable wind speeds, rain, and the topography of the field. Additionally, as the crop residue is discharged from an agricultural machine, dust particles may form which may impede sensing the spread of the crop residue on the field.

To control the distribution of crop residue from the agricultural machine, the agricultural machine may include a spreader. The spreader is a tool coupled to the agricultural machine generally at a location towards or at the rear of the agricultural machine. The crop residue, which is cut and processed in the agricultural machine, is delivered to the spreader which can include vanes or deflectors which control the discharge of crop residue from the agricultural machine. The vanes or deflectors can be controlled by an operator or controller of the agricultural machine to control the distribution of crop residue.

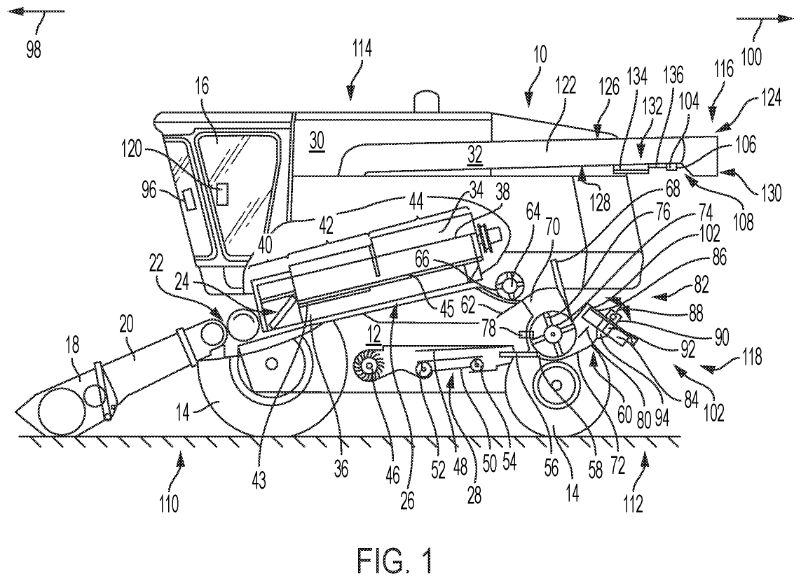

In FIG. 1, an implementation of an agricultural machine 10 is shown. In this implementation, the agricultural machine 10 is depicted as an agricultural combine 10. The present disclosure, however, is not limited to an agricultural combine or any other agricultural vehicle. The agricultural machine 10 may be any type of agricultural, construction, forestry, industrial, or off-road machine or vehicle.

The agricultural machine 10 includes a frame or chassis 12 and one or more ground engaging mechanism, such as wheels 14 or tracks, that are in contact with an underlying ground surface. The chassis 12 may include a first end 110 and a second end 112. The first end 110 is located at a forward end of the combine 10 whereas the second end 112 is located at a rearward end thereof. In the illustrative implementation, the wheels 14 are coupled to the frame or chassis 12 and are used for propulsion of the agricultural machine 10 in a forward operating direction (which is to the left in FIG. 1 as indicated by arrow 98) and in other directions. In some implementations, operation of the agricultural machine 10 is controlled from an operator's cab 16. The operator's cab 16 may include any number of controls for controlling the operation of the agricultural machine 10, such as a user interface. In some implementations, operation of the agricultural machine 10 may be conducted by a human operator in the operator's cab 16, a remote human operator, or an automated system.

A cutting header 18 is disposed at a forward end of the agricultural machine 10 and is used to harvest crop (such as corn) and to conduct the harvested crop to a slope conveyor 20. The slope conveyor 20 conducts the harvested crop to a guide drum 22. The guide drum 22 guides the harvested crop to an inlet 24 of a threshing assembly 26, as shown in FIG. 1. The threshing assembly 26 includes a housing 34 and one or more threshing rotors. A single threshing rotor 36 is shown in FIG. 1, and the threshing rotor 36 includes a drum 38. The threshing assembly 26 includes a charging section 40, a threshing section 42, and a separating section 44. The charging section 40 is arranged at a front end of the threshing assembly 26, the separating section 44 is arranged at a rear end of the threshing assembly 26, and the threshing section 42 is arranged between the charging section 40 and the separating section 44.

Harvested crop that includes grain, such as corn, and material other than grain (MOG) falls through a thresher basket 43 positioned in the threshing section 42 and through a separating grate 45 positioned in the separating section 44. The harvested crop may be directed to a clean crop routing assembly 28 with a blower 46 and sieves 48, 50 with louvers. The sieves 48, 50 can be oscillated in a fore-and-aft direction. The clean crop routing assembly 28 removes the MOG and guides grain over a screw conveyor 52 to an elevator for grain. The elevator for grain deposits the grain in a grain tank 30, as shown in FIG. 1. The grain in the grain tank 30 can be unloaded by an unloading member 32, such as an unloading conveyor or auger to a grain wagon, trailer, or truck, for example. For purposes of this disclosure, the unloading member 32 is referred to hereinafter as an unloading conveyor 32. The unloading conveyor 32 may have a first end 114 and a second end 116. The first end 114 of the unloading conveyor 32 may be pivotally coupled to the chassis 12, and the second end 116 of the unloading conveyor 32 may overhang the second end 112 of the chassis 12. In some implementations, the unloading conveyor 32 may be foldable.

Harvested crop remaining at an end of the lower sieve 50 is again transported to the threshing assembly 26 by a screw conveyor 54 where it is reprocessed by the threshing assembly 26. Harvested crop delivered at an end of the upper sieve 48 is conveyed by an oscillating sheet conveyor 56 to a lower inlet 58 of a chopper rotor assembly 60. Harvested crop at the threshing assembly 26 is processed by the separating section 44 resulting in straw being separated from other material of the harvested crop. The straw is ejected through an outlet 62 of the threshing assembly 26 and conducted to an ejection drum 64. The ejection drum 64 interacts with a sheet 66 arranged underneath the ejection drum 64 to move the straw in a rearward direction indicated by arrow 100 in FIG. 1. A wall 68 is located to the rear of the ejection drum 64 and guides the straw into an upper inlet 70 of the chopper rotor assembly 60.

The chopper rotor assembly 60 includes a chopper housing 72 and a chopper rotor 74 arranged in the chopper housing 72 that rotates, for example, in a counter-clockwise direction about an axis that extends, for example, perpendicular to the forward operating direction indicated by arrow 98 in FIG. 1. The chopper rotor 74 includes a plurality of chopper knives 76 that are distributed around a circumference of the chopper rotor 74. The chopper knives 76 interact with opposing knives 78, which are, for example, coupled to the chopper housing 72. The chopper knives 76 and the opposing knives 78 cooperate to chop the straw into smaller pieces.

One or more spreaders are provided downstream of an outlet 80 of the chopper rotor assembly 60. One spreader 82 is shown in FIG. 1. The spreader 82 may include a number of impeller blades 84, each of which is connected to a disk 86 that rotates about a central axis 88. The impeller blades 84 extend downwardly from the disk 86 and, for example, radially outwardly from the central axis 88. The disk 86 and the impeller blades 84 coupled thereto are rotatably driven by a hydraulic motor 90. Chopped straw is moved through the outlet 80 of the chopper rotor assembly 60 to the spreader 82. Rotation of the impeller blades 84 of the spreader 82 spreads the chopped straw as it exits the agricultural machine 10, the chopped straw being discharged from the spreader may be referred to as residue.

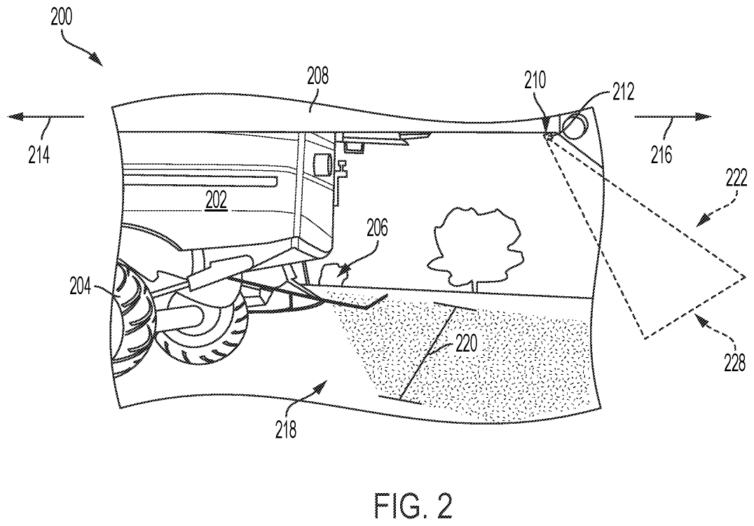

The spreader 82 may discharge residue in the rearward direction 100 relative to the agricultural combine 10, or in a sideways direction. Rotation of the impeller blades 84 may discharge residue out of the spreader outlet 118. In some implementations, when residue is discharged from the agricultural combine 10 there may be particles in the air, hereinafter referred to as dust 218 (see FIG. 2). The residue may settle on the underlying ground at an approximately consistent width, referred to as a residue spread width 220. The residue spread width 220 may be one of several dimensions or characteristics that define the spread pattern. The width 220 may include a horizontal dimension and transverse dimension with respect to a forward direction 98 of the agricultural combine 10, and the spread pattern may be adjusted by controlling the agricultural combine 10. In one implementation, the spread pattern may be adjusted by adjusting the speed of the impeller blades 84 of the spreader 82. In some implementations, the spread pattern may be adjusted by adjusting the speed of the chopper rotor 74 within the chopper rotor assembly 60. In another implementation, the spread pattern may be adjusted by adjusting the direction or angular orientation of a deflector or shroud connected to the spreader 82. In some implementations, one or more of these adjustment techniques may be applied to adjust the spread pattern. These adjustments may adjust the residue spread width 220, a spread edge, distributed amount of spread residue, and other spread performance data.

In the implementation of FIG. 1, a sensor 104 is coupled to the unloading conveyor 32. In one implementation, the sensor 104 may also be electrically coupled to or otherwise in communication with a controller 106, and the sensor 104 may be located within a housing 108 coupled to the unloading conveyor 32. The controller 106 may include a memory unit and processor unit. The memory unit may be capable of storing algorithms, processes, programs, input, software, look up tables, data, charts, diagrams, etc. In one implementation, as illustrated in FIG. 1, the controller 106 and sensor 104 are located within the same housing 108 coupled to the unloading conveyor 32. In another implementation, neither the controller 106 nor the sensor 104 are located within a housing. In another implementation, the controller 106 and sensor 104 are located in separate housings. In some implementations, more than one sensor 104 is coupled to the unloading conveyor 32. In one implementation, there may be more than one controller 106. In some implementations, the sensor 104 may be an optical sensor, such as a camera. In one implementation, the sensor is one or more of a radar, LIDAR, ultrasonic sensor, thermal sensor, infrared sensor, or any other sensor known in the art.

In several implementations, the sensor 104 is pivotally coupled to the unloading conveyor 32. In one implementation, the sensor 104 is rotatably coupled to the unloading conveyor 32. In one implementation, the sensor 104 is coupled to the unloading conveyor 32 in such a way that the sensor 104 does not move with respect to the unloading conveyor 32. In other implementations, the sensor 104 is moveably coupled to the unloading conveyor 32.

As illustrated in FIG. 1, the sensor 104 is coupled to a bottom portion 128 of the unloading conveyor 32. In other implementations, the sensor 104 may be coupled to a side portion of the unloading conveyor 32, such as a first side portion 122 or a second side portion 124. In some examples, the unloading conveyor 32 may have a circular cross-section with a curved surface defined along the circumference of the circular cross-section. In these examples, the sensor 104 may be coupled to the unloading conveyor 32 at any location along the circumferential surface of the unloading conveyor 32. In another implementation, the sensor 104 may be coupled to a top portion 126 of the unloading conveyor 32. In other implementations, the sensor 104 may be coupled to a rear portion 130 of the unloading conveyor 32. The sensor 104 may be located at any location between the first end 114 and the second end 116 of the unloading conveyor 32.

In some implementations, the sensor 104 is movable between one or more locations along or around the unloading conveyor 32. The one or more locations may include a surface on the first side portion 122, the second side portion 124, the top portion 126, the bottom portion 128, the rear portion 130, a radial portion, or any other surface of the unloading conveyor 32. In one example, the sensor 104 is positioned at a first location and moves to a second location. The second location may be any position on the unloading conveyor 32 other than the first location. In some implementations, the sensor is movable between a first location, a second location, and another location on the unloading conveyor 32.

In one example, the first location may be a location on the bottom portion 128 of the unloading conveyor 32 and the second location may be another location on the bottom portion 128 of the unloading conveyor 32. For example, the first location may be on the bottom portion 128 and closer to the first end 114 of the unloading conveyor 32, and the second location may be on the bottom portion 128 of the unloading conveyor 32 and closer to the second end 116 of the unloading conveyor 32.

In another example, a first location may be on the bottom portion 128 of the unloading conveyor 32, a second location may be on a side portion 122, 124 of the unloading conveyor 32, and a third position may be on the rear portion 130 of the unloading conveyor. In this example, the sensor 104 may be coupled at the first location on the unloading conveyor 32 and be controllably moved to the second location on the first side portion 122 or second side portion 124 of the unloading conveyor 32. The sensor 104 may then be controllably moved from the second location to the third location on the rear portion 130 of the unloading conveyor 32.

In some implementations, after moving from one location to another location, the sensor 104 may then be moved to one or more other locations. The one or more other locations may be anywhere on the unloading conveyor 32 that is not the first location or the second location. In some implementations, the sensor 104 may be controllably pivoted or rotated with respect to the unloading conveyor 32. For example, the sensor 104 may be coupled to the unloading conveyor 32 at a first location where a controller 106 controls a pivotal or rotational movement of the sensor 104 relative to the unloading conveyor 32. The sensor 104 may be controllably moved to a second location where the controller 106 controls a pivotal or rotational movement relative to the unloading conveyor 32. The sensor 104 may be controllably moved from one location to one or more other locations on the unloading conveyor 32 where the sensor is controllably pivoted or rotated at any of these locations. The ability to control a movement of the sensor 104, whether it be a linear, pivotal, or rotational movement relative to the unloading conveyor 32, may allow the sensor 104 to achieve better sensing of the crop residue spread pattern as the crop residue is discharged from a rear of the agricultural machine 10. Further, controlling the movement and location of the sensor 104 along the unloading conveyor 32 allows the sensor 104 to sense the spread pattern of the crop residue with less impact from dust particles being discharged with the crop residue from the agricultural machine 10. Thus, with improved sensing, the sensor 104 is better able to communicate to the controller 106 or operator various characteristics of the crop residue spread pattern, as described in more detail below. In turn, the controller 106 may detect various characteristics associated with the residue spread pattern based on the output from the sensor 104.

In some implementations, the sensor 104 may be controllably moved or pivoted relative to the unloading conveyor 32 via a linear actuator 132, such as shown in FIG. 1. In one example, the linear actuator 132 includes a base or cylinder portion 132 and a rod portion 134. The base portion 132 is coupled to the unloading conveyor and the rod portion 134 is coupled to the sensor 104. The rod portion 134 moves linearly relative to the base portion 132 to induce linear or pivotal movement of the sensor 104 relative to the unloading conveyor 32. In one example, the sensor 104 is movable relative to the unloading conveyor 32 as the rod portion 134 extends and retracts relative to the base portion 132. In another example, the sensor 104 is coupled to the unloading conveyor 32 such that the sensor 104 is pivotal relative to the unloading conveyor 32 as the rod portion 134 extends and retracts relative to the unloading conveyor 32. In one example, the sensor 104 is coupled to the unloading conveyor 32 via a track (not shown) coupled to or formed in the unloading conveyor 32 such that extension or retraction of the rod portion 134 induces linear movement of the sensor 104 along the track relative to the unloading conveyor 32.

In one implementation, a rotary actuator is provided to move the sensor 104 relative to the unloading conveyor 32. In other implementations, a track is coupled to the unloading conveyor 32 and a motor controllably moves the sensor 104 along the track. In some implementations, an actuator, a motor, or both may controllably move the sensor 104 relative to the unloading conveyor 32. The actuator and motor may be hydraulically controlled. In another example, the actuator or motor may be electric. In some implementations, input from an operator may controllably move the sensor 104 relative to the unloading conveyor 32. The operator may be located on or remote from the agricultural machine 10. In some examples, the sensor 104 may be automatically controlled by the controller 106. For example, the sensor 104 may send an output to the controller 106, and the controller 106 may analyze the output or other information (e.g., commands, data, instructions, etc.) and then controllably move the sensor 104 to another location on the unloading conveyor 32 to further sense the crop residue being discharged from the agricultural machine 10. For example, the other information may include a command associated with a change in position of the unloading conveyor. In another example, the controller 106 may send a command to a device such as an actuator or motor, and the device may controllably move the sensor 104 to another location or orientation relative to the unloading conveyor 32.

In several implementations, the controller 106 is communicatively coupled to an output mechanism. The output mechanism may be located on or remote from the agricultural machine 10. In one example, the output mechanism is a display screen 120 as shown in FIG. 1. In this example, the output mechanism or display screen 120 receives an output from the controller 106 and displays the corresponding output for an operator in the cab 16 of the agricultural machine 10. In another example, the output mechanism is a device such as a laptop, mobile phone, tablet, or control device. The device may be located on the agricultural machine 10 or remote from the agricultural machine 10. Thus, a third party besides the operator of the agricultural machine 10, e.g., a farmer, may receive the output from the controller 106. In a further example, the output mechanism is a control system that is capable of controlling one or more functions on the agricultural machine 10. In one example, the control system is another controller capable of receiving the output from the controller 106 and controlling a function on the agricultural machine 10 (e.g., a speed of the spreader 82). In another example, the control system may include one or more actuators capable of controlling the spreader 82, chopper rotor assembly 60, or any other device on the agricultural machine 10 in response to the output from the controller 106. Moreover, the output mechanism may be one or more actuators capable of controlling the speed of the spreader 82, the shroud position of the spreader 82, the chopper speed, the spread pattern (e.g., the residue spread width 220 may be one of several dimensions or characteristics that define the spread pattern), or any other function on the agricultural machine 10. In yet another example, the control system may receive the output from the controller 106, analyze the output, and generate a corresponding response based on the output. Alternatively, the output mechanism may receive the output, analyze the output, and transmit a signal based on the output to another control system on the agricultural machine 10 for performing a function on the agricultural machine 10.

In one implementation, the output mechanism is a display screen 120 within the operator's cab 16, and the display screen 120 displays the output for an operator to view. In this implementation, the operator may analyze the information on the display screen 120 and make an adjustment to the spread pattern or position of the sensor 104 relative to the unloading conveyor 32. In another implementation, the output mechanism analyzes the output and sends the analysis to a control system (not shown), and the control system automatically adjusts the spread pattern. In one implementation, the output mechanism or control system is located onboard or remote from the agricultural combine 10.

Referring now to FIGS. 2-4, an agricultural machine 200 similar to the agricultural machine 10 of FIG. 1 is shown. For example, the agricultural machine 200 may include a chassis 202, one or more ground engaging mechanisms 204, a header 18, a spreader 206, and an unloading conveyor 208. The ground engaging mechanisms 204 move the agricultural machine 200 in a forward direction indicated by arrow 214 in a field. The header 18 is coupled to a first or front end of the agricultural machine 200 to cut crop material in the field. In one implementation, the header 18 cuts and conveys the crop material into the agricultural machine 200 where the crop material passes through a threshing section 42, a separating section 44, a cleaning section 28, and a chopper rotor assembly 60 (see, e.g., FIG. 1). Crop residue and other particles (e.g., MOG) is to be conveyed to the spreader 206, which discharges the crop residue and other particles in a rearward direction indicated by arrow 216 from the agricultural machine 200. While in FIGS. 2-4 only one spreader 206 is shown, in other implementations the agricultural machine 200 may include a plurality of spreaders 206.

In some implementations, the unloading conveyor 208 may overhang and extend rearwardly from a rear end 112 of the agricultural machine 200. As shown, at least one sensor 210 is coupled to the unloading conveyor 208. In some implementations, the sensor 210 is coupled to or disposed in communication with a controller 212. In one implementation, the sensor 210 is coupled to a side portion of the unloading conveyor 208. In some examples, as illustrated in FIGS. 2-4, the sensor 210 is coupled to a bottom portion of the unloading conveyor 208. In another example, the sensor 210 is coupled to a top portion of the unloading conveyor 208. In a further example, the sensor 210 is coupled to an end portion of the unloading conveyor 208. In other examples, the sensor 210 is coupled to the unloading conveyor 208 and located rearward of the spreader 206. In yet other implementations, the sensor 210 is coupled to the unloading conveyor 208 and located forward of the spreader 206. In some implementations, the sensor 210 may be coupled via a bracket or other mechanism (e.g., a housing) to the unloading conveyor 208 such that the sensor 210 is positioned at a different location on the unloading conveyor relative to where the bracket or other mechanism is actually coupled to the unloading conveyor 208.

In one implementation, the sensor 210 is coupled to or located on the unloading conveyor 208 and the unloading conveyor 208 may move between at least a first position and a second position. In this example, the sensor 210 may be located rearward of the spreader 206 when the unloading conveyor 208 is in the first position, and the sensor 210 may be forward of the spreader 206 when the unloading conveyor 208 is moved to the second position. In some implementations, there may be a plurality of sensors 210 coupled to the unloading conveyor 208. In some implementations, the sensor 210 is coupled to or near a first end of the unloading conveyor 208, to or near an opposite end of the unloading conveyor 208, or at any location therebetween.

As crop residue is discharged from the agricultural machine 200 by the spreader 206, dust 218 may be discharged therefrom as well. When discharged from the agricultural machine 200, the crop residue settles on an underlying ground in the field in a residue spread pattern having a generally consistent width, which may be referred to as a residue spread width 220. In some instances, the dust 218 may at least partially obscure the sensor 210 from sensing the spread pattern if the sensor 210 is located in close proximity to the spreader 206. To overcome this issue, the present disclosure discloses one or more implementations where the sensor 210 is spaced or moved away from the spreader 206 to limit the impact of the dust 218 on the sensor's 210 ability to sense the residue spread pattern.

In one implementation, the sensor 210 is positioned to sense the spread pattern as crop residue is discharged by the spreader 206 from the agricultural machine 200. The sensor 210 may be coupled to the agricultural machine 10 at a distance from the spreader 206 such that the dust 218 does not prevent the sensor 210 from sensing the corresponding spread pattern of the crop residue. In some examples, as illustrated in FIG. 2, the sensor 210 is capable of sensing an area of the field with a first field of view 222 that at least partially includes a view of the underlying ground that is angled in a rearward direction 216 and generally below the location of the sensor 210 on the unloading conveyor 208. In some implementations, the first field of view 222 may capture the spread pattern as the residue is settling or has settled in the field.

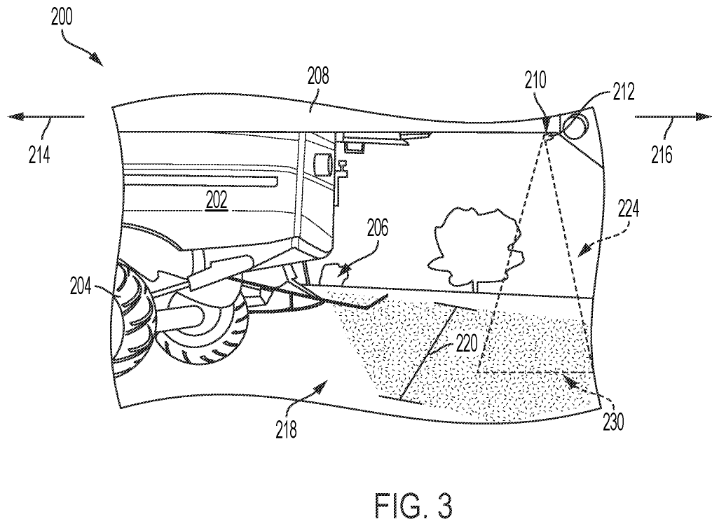

In another example, as illustrated in FIG. 3, the sensor 210 is capable of sensing an area in the field with a second field of view 224 that is oriented generally downwardly and perpendicular to the forward direction 214. In other words, the sensor 210 may be oriented downwardly to capture the general area directly below the sensor 210. The second field of view 224 at least partially includes an area of the field between the unloading conveyor 208 and the underlying ground. In this implementation, the sensor 210 captures the residue spread pattern as the crop residue is spreading, settling, or has settled in the field.

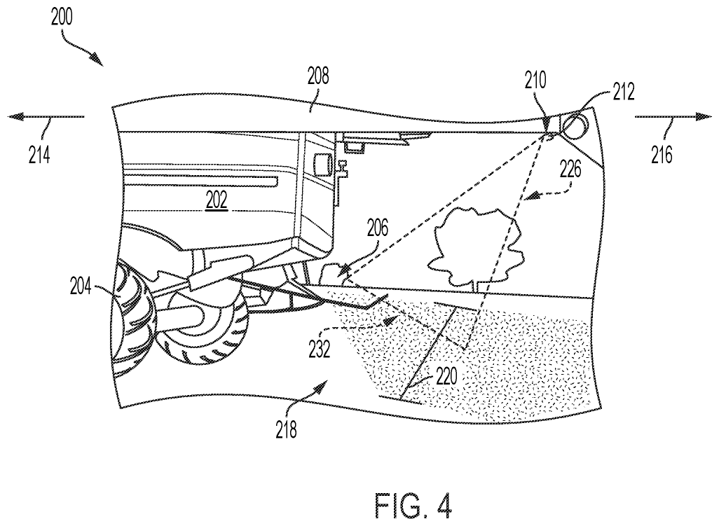

In a further example, as illustrated in FIG. 4, the sensor 210 is capable of sensing an area in the field with a third field of view 226 that at least partially includes a view that is oriented at an angle in a forward direction 214 and generally below the location of the sensor 210 on the unloading conveyor 208. In this illustrated example of FIG. 4, the unloading conveyor 208 extends at least partially rearward from the agricultural machine 200 such that the unloading conveyor 208 overhangs a portion of the field rearward of the spreader. Further, in FIG. 4, the area of the field sensed by the sensor 210 may be defined between the location of the spreader 206 and the location of the sensor 210 on the unloading conveyor 208. Moreover, with the third field of view 226, the sensor 210 senses the crop residue as it is discharged from the agricultural machine 200 by the spreader 206.

In some implementations, the sensor 210 may be a camera, radar, LIDAR, ultrasonic sensor, thermal sensor, infrared sensor, or any other sensor known in the art. In some implementations, the sensor 210 senses one or more of a first field of view 222 that includes an area that is at least partially rearward of the sensor 210 (FIG. 2), a second field of view 224 that includes an area generally directly below the sensor 210 (FIG. 3), and a third field of view 226 that includes an area that is at least partially forward of the sensor 210 (FIG. 4). In one implementation, the sensor 210 is capable of sensing a two-dimensional area via one of the field of views 222, 224, 226. In another implementation, the sensor 210 is capable of sensing a three-dimensional area via one of the field of views 222, 224, 226.

In the illustrated implementations of FIGS. 2-4, each field of view 222, 224, 226 may cover an area of the field having a circular cross-sectional shape with a diameter 228, 230, 232, or an area having a non-circular dimension. In one implementation, the field of view 222, 224, 226 may have a rectangular cross-section having a length and a width. In another implementation, the field of view 222, 224, 226 may have a multifaceted or multi-dimensional shaped cross-section.

In one implementation, each field of view 222, 224, 226 may include an area having a diameter 228, 230, 232 or a non-circular dimension that is larger than the residue spread width 220. In another implementation, the field of view 222, 224, 226 may include an area having a diameter 228, 230, 232 or a non-circular dimension that is about the same size as the residue spread width 220. In still another implementation, the field of view 222, 224, 226 may include an area having a diameter 228, 230, 232 or a non-circular dimension that is smaller than the residue spread width 220.

The agricultural machine 200 may have a header cut width that is approximately the width of the header 18. In one implementation, each field of view 222, 224, 226 includes an area that is larger than the header cut width. In another implementation, the sensor 210 with a field of view 222, 224, 226 may sense an area that is about the same size as the header cut width. In still another implementation, the field of view 222, 224, 226 may include an area that is smaller than the header cut width.

In one implementation of this disclosure, the sensor 210 is coupled to the unloading conveyor 208 of the agricultural machine 200 and senses an area of the field corresponding to the first field of view 222. In this implementation, the sensor 210 is also coupled to the controller 212, and the controller 212 is communicatively coupled to an output mechanism that is located on or remote from the agricultural machine 200. The sensed area of the first field of view 222 may be larger than, smaller than, or approximately the same size as the residue spread width 220. As such, the sensor 210 senses the spread pattern that is rearward of the sensor 210 as the residue is spreading, settling, or has settled. During a harvesting operation, the sensor 210 senses the residue that is discharged by the spreader 206 and sends an output to the controller 212. In turn, the controller 212 transmits the output to an output mechanism. In one example, the output mechanism is a display located in the operator's cab 16 of the agricultural machine 200 for displaying the output. An operator may then analyze the output on the display and make adjustments to the agricultural machine 200 to adjust the spread pattern. In a second implementation, the output mechanism may be, for example, a phone, tablet, or computer. In another implementation, the output mechanism receives the output from the controller 212 so that an operator or third party may analyze the output. Based on the analysis, adjustments may be made to the agricultural machine 200 to adjust the spread pattern. In a third implementation, the output mechanism receives the output from the controller 212, analyzes the output, and automatically makes adjustments to the agricultural machine 200 based on the analysis.

In another implementation, the sensor 210 is coupled to the unloading conveyor 208 and senses an area corresponding to the second field of view 224. Additionally, the sensor 210 is coupled to the controller 212, and the controller 212 is communicatively coupled to an output mechanism located on or remote from the agricultural machine 200. The second field of view 224 includes an area below the sensor 210. In some implementations, the sensor 210 senses an area of the field directly below the sensor 210 as it is coupled to the unloading conveyor 208. The second field of view 224 includes an area of the field that may be larger than, smaller than, or approximately the same size as the residue spread width 220. In this implementation, the sensor 210 senses the spread pattern as the residue is spreading, settling, or has settled. Moreover, the sensor 210 sends an output to the controller 212, and the controller 212 transmits the output to an output mechanism located on or remote from the agricultural machine 200. As described previously, in one implementation, the output mechanism may be a display screen 120 located in the operator's cab 16 of the agricultural machine 200. Alternatively, the output mechanism may be a phone, tablet, or computer. In some implementations, the output mechanism may include one or more actuators for controlling a function on the agricultural machine 200. In one implementation, the output mechanism may analyze the output from the sensor 210 and trigger an output response. Also, in further implementations, the output from the controller 212 may be analyzed and the agricultural machine 200 may be operably controlled via the controller 106 or the output mechanism to adjust the spread pattern. This control may be done either remotely from or onboard the agricultural machine 200.

In another implementation, the sensor 210 is coupled to the unloading conveyor 208 of the agricultural machine 200 and senses an area of a field corresponding to a third field of view 226. Here, the sensor 210 is coupled to the controller 212 and the controller 212 is communicatively coupled to an output mechanism located on or remote from the combine 200. The third field of view 226 includes an area of the field that is located in a generally forward direction 214 of the sensor 210. In other words, the sensor 210 may sense an area of the field defined between the spreader 206 (or rear of the agricultural machine 200) and the sensor 210. In FIG. 4, the diameter 232 or non-circular dimension of the third field of view 226 may be larger than, smaller than, or approximately the same size as the residue spread width 220. The sensor 210 therefore senses the residue as the residue is spreading or settling on the field. In one implementation, the sensor 210 senses the crop residue near or rearward of the spreader 206 as the crop residue is being discharged from the agricultural machine 200. The sensor 210 sends an output to the controller 212, and the controller 212 transmits the output to an output mechanism. As described above, the output mechanism may be a display screen 120, a phone, a tablet, a computer, or a system such as a control system. In some implementations, the output mechanism may include actuators for controlling a function on the agricultural machine 200. In one implementation, the output mechanism may analyze the output from the sensor 210 or controller 212 and output a corresponding response, e.g., control a function of the agricultural machine 200. The output from the controller 212 may be analyzed by the output mechanism and the agricultural machine 200 may be controlled to adjust the spread pattern.

In some implementations as previously described, the sensor 210 is moveably coupled to the unloading conveyor 208. For example, the sensor 210 may move along or pivot about the unloading conveyor 208 via an actuator (e.g., the actuator 132 in FIG. 1). to sense an area corresponding to the first field of view 222, the second field of view 224, or the third field of view 226. Additionally, the sensor 210 may move to sense fields of view in addition to the first field of view 222, the second field of view 224, and the third field of view 226. In one implementation, the sensor 210 is controllably moved by the actuator (e.g., actuator 132), which may be controlled by an operator from the operator's cab 16. In another implementation, the sensor 210 is controllably moved by an output mechanism, which may be remote from or onboard the agricultural machine 10. In this implementation, the controller 212 receives an output from the output mechanism and controllably moves the sensor 210 to another location via an actuator. In some implementations, the sensor 210 may sense an area that includes more than one of the first, second, and third fields of view 222, 224, 226. In another implementation, the sensor 210 may be a camera that is able to sense an area in a plurality of directions (e.g., three-dimensional). In several implementations, the sensor 210 may be a 360 degree camera. In other implementations, the sensor 210 is a camera that has a field of view between 90 degrees and 360 degrees. In yet other implementations, the sensor 210 is a camera that has a field of view of approximately 90 degrees. In some implementations, the sensor 210 is pivotally coupled to the unloading conveyor 208 so that the sensor 210 may pivot to sense additional fields of view.

In one implementation, the sensor 210 is a camera capable of zooming in or out. When the camera is zoomed-in, the area corresponding to the field of view 222, 224, 226 sensed by the sensor 210 may be smaller relative to the area sensed by the sensor 210 when the camera is zoomed-out.

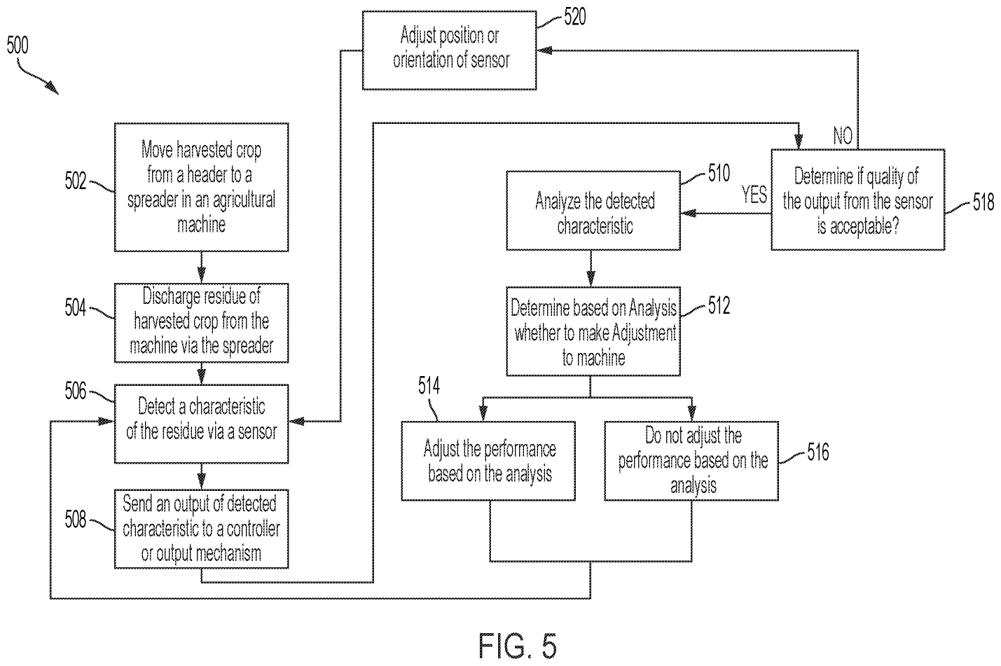

Referring now to FIG. 5, an illustrative method 500 of monitoring crop residue as it is discharged or has been discharged by an agricultural machine with a crop residue performance monitoring system is shown. The method 500 may include one or more blocks that are executable by an operator or controller. In some implementations, the method 500 may include additional or fewer blocks than shown in FIG. 5. In another implementation, the blocks shown in FIG. 5 may be executed in a different order.

In the illustrative method 500, an agricultural machine 10 similar to the agricultural machine depicted in FIGS. 1-4 is provided with a header 18, a spreader 82, 206, an unloading conveyor 32, 208, and a sensor 104, 210. The agricultural machine 10 may also include a controller 106 and an output mechanism (e.g., a display screen 120) for displaying data, analyzing data, or both. The output mechanism may be located on or remote from the agricultural machine 10.

In FIG. 5, the method 500 begins with block 502 as the agricultural machine 10, 200 moves through a field to perform a harvesting operation. In block 502, the agricultural machine 10, 200 harvests crop in the field such that the harvested crop is moved along a flow path defined between the header 18 and the spreader 82, 206. The flow path may include, among other things, the threshing section 42, the separating section 44, the cleaning system 28, and the rotor chopper 74 with chopper knives 76 that interact with opposing knives 78. In block 502, crop residue and other particles may be directed from the header 18 to the spreader 82, 206 along the flow path. Moreover, in block 502, the crop residue may be subject to threshing, separating, and chopping. As the crop is harvested by the agricultural machine, the method 500 advances from block 502 to block 504.

In block 504, the crop residue is discharged from the agricultural machine 10, 200 via the spreader 82, 206 to an underlying ground in the field. Moreover, in block 504, discharging the crop residue by the spreader 82, 206 from the agricultural machine 10 may produce dust particles 218 (see FIG. 2).

In block 506 of the method 500, a spread pattern of the crop residue forms rearward of or behind the spreader 82, 200 and is sensed by a sensor 104, 210 coupled to the unloading conveyor 32, 208 of the agricultural machine 10. The sensor 104, 210 senses a spread pattern of the discharged crop residue among other spread performance characteristics including, for example, a residue spread width 220 (see FIG. 2), a spread edge, and an amount of distributed residue. In one implementation, the sensor 104, 210 may be coupled to the unloading conveyor 32, 208 and may be oriented downwardly to sense the underlying ground and residue. In some implementations, the sensor 104, 210 may be an optical sensor, such as a camera. In one implementation, the sensor may be one or more of a radar, LIDAR, ultrasonic sensor, thermal sensor, infrared sensor, or any other sensor known in the art. The sensor 104, 210 may sense an area of the field corresponding to one or more field of views. One field of view is at least partially rearward of the sensor 104, 210, a second field of view is at least partially forward of the sensor 104, 210, and a third field of view is below the sensor 104, 210 and partially rearward and partially forward of the sensor 104, 210. In one example, the sensor 104, 210 transitions between one field of view to another field of view to sense the various areas of the underlying ground and the crop residue. In one example, the sensor 104, 210 senses the spread pattern by sensing the spread of the crop residue as the crop residue is discharged from the agricultural machine 10, 200 via the spreader 82, 206 including that which is in the air and not resting on the underlying ground. In another example, the sensor 104, 210 senses the spread pattern by sensing the spread of the crop residue after the crop residue is discharged from the spreader 82, 206 and continues spreading. In another example, the sensor 104, 210 senses the spread pattern by sensing the spread of the crop residue as the dust 218 and crop residue is at least partially settling on the underlying ground. In yet another example, the sensor 104, 210 senses the spread pattern by sensing the spread of the crop residue as the crop residue has settled on the underlying ground. Once the spread pattern of crop residue is sensed by the sensor 104, 210 in block 506, the method 500 proceeds to block 508.

In block 508, the spread pattern sensed by the sensor 104, 210 is output to a controller 106 or an output mechanism for processing. In one implementation, the output mechanism may be a display screen 120 located in the operator's cab 16. In some implementations, the output mechanism is located onboard the agricultural machine 10, 200 or remote from the agricultural machine 10, 200. In one example, the output mechanism may include a mobile device, a tablet, or a computer. In one example, the sensor 104, 210 may wirelessly transmit the information to the output mechanism. In some examples, the output mechanism is part of a control system that includes the controller 106 or a different controller. In another example, the sensor 104, 210 is coupled to the controller 106 such that the sensor 104, 210 transmits the information to the controller 106 and the controller 106 transmits the information to the output mechanism. In some examples, the controller 106 transmits the information to the display screen 120 and to one or more systems or devices, and the display screen 120 and one or more systems or devices may display the information. The controller 106 may include a memory unit and processor unit. The memory unit may be capable of storing algorithms, processes, programs, software, look up tables, data, charts, diagrams, etc. One example of an algorithm stored by the controller 106 is the algorithm for executing method 500. After block 508, the method 500 proceeds to block 518.

In block 518, the sensing of the spread pattern via the sensor 104, 210 may be evaluated or detected by a controller 106, 212 or operator. In some implementations, the quality of the output from the sensor 104, 210 may be insufficient to accurately analyze the crop residue. In one implementation, the output from the sensor 104, 210 from block 508 may be compared to a threshold that is representative of a minimum quality needed for an accurate analysis. If the comparison results in the quality of the output from the sensor 104, 210 not being satisfactory (i.e., does not satisfy the threshold), then the method 500 advances to block 520. If the location of the sensor 104, 210 is such that the output from the sensor 104, 210 is insufficient to enable the spread pattern to be detected accurately (i.e., dust particles 218 obscures the ability of the sensor 104, 210 to sense the spread pattern of crop residue), the sensor 104, 210 may be relocated relative to the unloading conveyor 208 in block 520. An actuator 132, for example, may be operably controlled to move or pivot the sensor 104, 210 to enable the sensor 104, 210 to be repositioned or reoriented to better sense the spread pattern of the crop residue being discharged from the agricultural machine 10, 200. In other implementations, an operator of the agricultural machine 10, 200 may send commands to operably control the actuator 132 to move or pivot the sensor 104, 210 to another location relative to the unloading conveyor 208 or a different orientation for sensing the spread pattern of crop residue. In some implementations of block 520, movement of the sensor 104, 210 can cause the sensor 104, 210 to sense an area of the field corresponding to a different field of view. In other implementations, a pivotal movement of the sensor 104, 210 can cause the sensor 104, 210 to sense the same area of the field but at a different angle relative to the unloading conveyor 208. As the sensor 104, 210 is moved or repositioned in block 520, the method 500 returns to block 506 for the sensor 104, 210 to sense the spread pattern or distribution of crop residue being discharged or having been discharged from the agricultural machine by the spreader. The method 500 may then proceed to blocks 508 and 518 as described previously.

If, in block 518, the output from the sensor satisfies the threshold and thus the quality of the output from the sensor 104, 210 is acceptable, the method 500 advances to block 510.

In block 510, a characteristic of the crop residue is analyzed. The spread pattern is one type of characteristic of the crop residue that may be sensed by the sensor 104, 210 and detected or otherwise evaluated by a controller, output mechanism or other processor (including the operator who is controlling the agricultural machine). In other implementations, other types of characteristics of the crop residue may be sensed in block 506 and analyzed in block 510. In one implementation, the spread pattern of the crop residue is sent to the display screen 120 where the spread pattern is displayed and analyzed by an operator such as, for example, an operator of the agricultural machine 10, 200. In some implementations, the spread pattern is sent to an output mechanism other than the display screen 120 (e.g., a mobile phone, a tablet, a laptop, etc.). The output mechanism may be located onboard the agricultural machine 10, 200 or remote from the agricultural machine 10, 200. In one example, the output mechanism analyzes the spread pattern and outputs a corresponding instruction or command to adjust the performance of the agricultural machine 10, 200 based on the analysis. In other examples, the output mechanism receives the spread pattern and an operator analyzes the spread pattern. In some examples, the output mechanism performs an analysis autonomously and transmits the results of the analysis to the display screen 120 to display the results. The operator may view the results on the display screen 120. After block 510 is executed, the method 500 proceeds to block 512.

In block 512, a determination is made whether to make an adjustment to the agricultural machine 10, 200 based on the sensed characteristic (e.g., spread pattern). In one example, an operator may analyze the spread pattern sensed by the sensor 104, 210 and make a determination. In another implementation, the determination is made by an output mechanism on or remote from the agricultural machine 10, 200. In one implementation, a controller 106 performs the analysis of the spread pattern and determines whether an adjustment is needed.

After block 512, the method 500 proceeds to either block 514 or block 516. The method 500 proceeds to block 514 if the analysis determines that the performance of the agricultural machine 10, 200 needs to be adjusted. Otherwise, if no adjustment is needed, the method 500 proceeds to block 516.

In block 514, the performance of the agricultural machine 10, 200 is adjusted based on the analysis made in block 510. In one example, an operator may adjust the agricultural machine 10, 200 based on the analysis. In another example, the agricultural machine 10, 200 may be adjusted by the controller 106 without input from an operator. In some examples, an output mechanism (e.g., via a mobile phone, a tablet, or laptop remote from the agricultural machine 10, 200) may adjust the performance of the agricultural machine 10, 200 based on the analysis. In one implementation, the agricultural machine 10, 200 may be adjusted by making changes to the spread pattern. For example, the spread pattern may be controlled by adjusting the speed of the impeller blades 84, the speed of the chopper rotor 74 within the chopper rotor assembly 60, or the direction of a deflector that may be connected to the spreader 82, 206. Alternatively, other adjustments to the performance of the agricultural machine 10, 200 may be made such as controlling the speed of the agricultural machine 10, 200 as it travels through the field.

In block 516, the performance of the agricultural machine 10 is not adjusted based on the analysis made in block 510 and the determination made in block 512. Whether an adjustment is made, following the execution of block 514 or 516 is executed, the method 500 returns to block 506 where the spread pattern of the crop residue is continuously monitored by the sensor 104, 210.

In this application, including the definitions below, the term “module” or the term “controller” may be replaced with the term “circuit.” The term “module” may refer to, be part of, or include: an Application Specific Integrated Circuit (ASIC); a digital, analog, or mixed analog/digital discrete circuit; a digital, analog, or mixed analog/digital integrated circuit; a combinational logic circuit; a field programmable gate array (FPGA); a processor circuit (shared, dedicated, or group) that executes code; a memory circuit (shared, dedicated, or group) that stores code executed by the processor circuit; other suitable hardware components that provide the described functionality; or a combination of some or all of the above, such as in a system-on-chip.

Some or all hardware features of a module may be defined using a language for hardware description, such as IEEE Standard 1364-2005 (commonly called “Verilog”) and IEEE Standard 1076-2008 (commonly called “VHDL”). The hardware description language may be used to manufacture and/or program a hardware circuit. In some implementations, some or all features of a module may be defined by a language, such as IEEE 1666-2005 (commonly called “SystemC”), that encompasses both code, as described below, and hardware description.

The term code, as used above, may include software, firmware, and/or microcode, and may refer to programs, routines, functions, classes, data structures, and/or objects. The term shared processor circuit encompasses a single processor circuit that executes some or all code from multiple modules. The term group processor circuit encompasses a processor circuit that, in combination with additional processor circuits, executes some or all code from one or more modules. References to multiple processor circuits encompass multiple processor circuits on discrete dies, multiple processor circuits on a single die, multiple cores of a single processor circuit, multiple threads of a single processor circuit, or a combination of the above. The term shared memory circuit encompasses a single memory circuit that stores some or all code from multiple modules. The term group memory circuit encompasses a memory circuit that, in combination with additional memories, stores some or all code from one or more modules.

The term memory circuit is a subset of the term computer-readable medium. The term computer-readable medium, as used herein, does not encompass transitory electrical or electromagnetic signals propagating through a medium (such as on a carrier wave); the term computer-readable medium may therefore be considered tangible and non-transitory. Non-limiting examples of a non-transitory computer-readable medium are nonvolatile memory circuits (such as a flash memory circuit, an erasable programmable read-only memory circuit, or a mask read-only memory circuit), volatile memory circuits (such as a static random access memory circuit or a dynamic random access memory circuit), magnetic storage media (such as an analog or digital magnetic tape or a hard disk drive), and optical storage media (such as a CD, a DVD, or a Blu-ray Disc).

The apparatuses and methods described in this application may be partially or fully implemented by a special purpose computer created by configuring a general purpose computer to execute one or more particular functions embodied in computer programs. The functional blocks and flowchart elements described above serve as software specifications, which can be translated into the computer programs by the routine work of a skilled technician or programmer.

The computer programs include processor-executable instructions that are stored on at least one non-transitory computer-readable medium. The computer programs may also include or rely on stored data. The computer programs may encompass a basic input/output system (BIOS) that interacts with hardware of the special purpose computer, device drivers that interact with particular devices of the special purpose computer, one or more operating systems, user applications, background services, background applications, etc.

The computer programs may include: (i) descriptive text to be parsed, such as HTML (hypertext markup language), XML (extensible markup language), or JSON (JavaScript Object Notation), (ii) assembly code, (iii) object code generated from source code by a compiler, (iv) source code for execution by an interpreter, (v) source code for compilation and execution by a just-in-time compiler, etc. As examples only, source code may be written using syntax from languages including C, C++, C#, Objective-C, Swift, Haskell, Go, SQL, R, Lisp, Java®, Fortran, Perl, Pascal, Curl, OCaml, JavaScript®, HTML5 (Hypertext Markup Language 5th revision), Ada, ASP (Active Server Pages), PHP (PHP: Hypertext Preprocessor), Scala, Eiffel, Smalltalk, Erlang, Ruby, Flash®, Visual Basic®, Lua, MATLAB, SIMULINK, and Python®.

None of the elements recited in the claims are intended to be a means-plus-function element within the meaning of 35 U.S.C. § 122(f) unless an element is expressly recited using the phrase “means for,” or in the case of a method claim using the phrases “operation for” or “step for.”

While exemplary implementations incorporating the principles of the present disclosure have been described herein, the present disclosure is not limited to such implementations. Instead, this application is intended to cover any variations, uses, or adaptations of the disclosure using its general principles. Further, this application is intended to cover such departures from the present disclosure as come within known or customary practice in the art to which this disclosure pertains.

1. An agricultural machine, comprising:
a chassis;
a header coupled to the chassis, the header configured to harvest a crop in a field;
a spreader coupled to the chassis, the spreader configured to discharge a residue of the harvested crop in a rearward direction from the agricultural machine;
an unloading conveyor comprising a first end and a second end, the first end of the unloading conveyor coupled to the chassis and the second end extending from the chassis; and
a sensor adjustably coupled to the unloading conveyor, the sensor configured to sense a characteristic of the residue as the residue is discharged from the machine by the spreader or has settled in the field;
wherein the sensor is movably adjustable relative to the unloading conveyor.

2. The agricultural machine of claim 1, wherein the sensor is directly coupled to the unloading conveyor and disposed at a location that is rearward of the spreader.

3. The agricultural machine of claim 1, wherein the sensor is pivotally coupled to the unloading conveyor.

4. The agricultural machine of claim 1, wherein the sensor is movably adjustable relative to the unloading conveyor to move between at least one of a top portion, a bottom portion, a first side portion, a second side portion, and a rear portion of the unloading conveyor.

5. The agricultural machine of claim 4, wherein the sensor is movably adjustable relative to the unloading conveyor by a linear actuator or a rotary actuator.

6. The agricultural machine of claim 4, wherein the unloading conveyor comprises a track to which the sensor is movably coupled, the sensor being movable along the track to any of a plurality of locations on the unloading conveyor.

7. The agricultural machine of claim 1, wherein the sensor comprises a camera, radar, LIDAR, an ultrasonic sensor, infrared sensor, or a thermal sensor.

8. The agricultural machine of claim 1, wherein the sensor is coupled to the unloading conveyor at a first location that is rearward of the spreader, the sensor being positioned to sense an area of the field that is forward of the first location and rearward of the spreader.

9. The agricultural machine of claim 1, wherein the sensor is coupled to the unloading conveyor at a first location and positioned relative to the agricultural machine to sense an area of the field that is directly below the first location.

10. The agricultural machine of claim 1, wherein the sensor is coupled to the unloading conveyor at a first location and positioned relative to the agricultural machine to sense an area of the field that is rearward of the first location.

11. The agricultural machine of claim 1, further comprising a controller disposed in communication with the sensor, the sensor configured to output the characteristic of the residue to the controller;
wherein, the controller analyzes the characteristic of the residue and controllably adjusts a function of the agricultural machine to adjust the characteristic of the residue.

12. The agricultural machine of claim 11, wherein the controller controllably adjusts a speed of the spreader, a shroud position of the spreader, or a spread pattern.

13. An agricultural machine for harvesting crop, comprising:
a chassis;
a header coupled to the chassis, the header configured to harvest crop in a field;
a spreader coupled to the chassis, the spreader configured to discharge a residue of the harvested crop in a rearward direction from the agricultural machine;
an unloading conveyor comprising a first end and a second end, the first end of the unloading conveyor movably coupled to the chassis and the second end extending outwardly from the chassis; and
a sensor coupled to the unloading conveyor, the sensor configured to sense a characteristic of the residue discharged from the spreader;
wherein the sensor is coupled to a top portion or side portion of the unloading conveyor.

14. The agricultural machine of claim 13, wherein the unloading conveyor extends outwardly from the chassis in the rearward direction and overhangs a portion of the field rearward of the agricultural machine, the sensor located at a first location on the unloading conveyor at a distance spaced rearwardly of the spreader;
wherein the sensor is oriented in a forward direction to sense an area of the field defined between the spreader and the first location.

15. The agricultural machine of claim 13, wherein the sensor is pivotally coupled to the unloading conveyor.

16. The agricultural machine of claim 13, wherein the sensor is movably coupled to the unloading conveyor.

17. The agricultural machine of claim 16, wherein the sensor is movable relative to the unloading conveyor to any of a plurality of locations on the top portion, a bottom portion, the side portion, and a rear portion of the unloading conveyor.

18. A method of controlling a spread pattern of crop residue discharged from an agricultural machine during a harvesting operation, comprising:
providing the agricultural machine with a header, a spreader, an unloading conveyor, and a sensor;
harvesting a crop in a field by the header;
discharging the crop residue by the spreader from the agricultural machine;
positioning the sensor at a location on the unloading conveyor that is spaced rearwardly of the spreader;
orienting the sensor in a forward direction towards the agricultural machine to sense an area of the field defined between the spreader and the location of the sensor on the unloading conveyor; and
sensing a distribution of the crop residue by the sensor as the crop residue is discharged from the agricultural machine or has settled in the area of the field.

19. The method of claim 18, further comprising:
outputting by the sensor an output signal indicative of the distribution of the crop residue;
determining if a quality of the output signal satisfies a threshold;
operably moving the sensor to a new location or new orientation relative to the unloading conveyor if the quality of the output signal does not satisfy the threshold; and
repeatedly sensing the distribution of the crop residue until the quality of the output signal satisfies the threshold.

20. The method of claim 18, further comprising:
analyzing the output signal to determine the spread pattern of the crop residue;
determining based on the spread pattern if a function of the agricultural machine needs to be adjusted; and
adjusting the function of the agricultural machine if the agricultural machine is determined to need adjustment.
